(19) United States
(12) Patent Application Publication
(10) Pub. No.: US 2010/0225837 A1
(43) Pub. Date: Sep. 9, 2010

(54) DISPLAY MEDIUM, DISPLAY DEVICE AND METHOD OF OPTICAL WRITING

(75) Inventors: Mieko SEKI, Kanagawa (JP); Yasuhiro YAMAGUCHI, Kanagawa (JP); Tomozumi UESAKA, Kanagawa (JP); Hideo KOBAYASHI, Kanagawa (JP); Hiroe OKUYAMA, Kanagawa (JP); Masaaki ARAKI, Kanagawa (JP); Motohiko SAKAMAKI, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/640,162

(22) Filed: Dec. 17, 2009

(30) Foreign Application Priority Data
Mar. 9, 2009 (JP) 2009-054878
Oct. 6, 2009 (JP) 2009-232645

(51) Int. Cl. G02F 1/135

(52) U.S. Cl. 349/25

(57) ABSTRACT

The invention provides a display medium including: a first electrode; a second electrode; a liquid crystal layer provided between the first electrode and the second electrode; a photoconductive layer provided between the second electrode and the liquid crystal layer, the photoconductive layer absorbing light of a predetermined wavelength used for writing, and thereby exhibiting an electrical characteristic corresponding to the intensity distribution of the light used for writing; a first light absorption layer provided between the liquid crystal layer and the photoconductive layer, the first light absorption layer absorbing light transmitted through the liquid crystal layer; a second light absorption layer provided at the side of the second electrode not facing the photoconductive layer, the second light absorption layer allowing transmission of the light used for writing and having an absorbance of 1 or more with respect to light of any wavelength in a range of from 300 nm to 550 nm.

### CROSS-REFERENCE TO RELATED APPLICATION

This application based on and claims priority under 35 USC 119 from Japanese Patent Application Nos. 2009-054878 filed Mar. 9, 2009 and 2009-232645 filed Oct. 6, 2009.

### BACKGROUND

1. Technical Field

The present invention relates to a display medium, a display device, and a method of optical writing.

2. Related Art

Expectations for display media have been increasing in the field of rewritable marking techniques, as an alternative hard copy medium to paper media, from the viewpoint of meeting global environmental concerns such as forest protection, or improving office environments by space saving.

Paper hard copies have such advantages as: (1) being bright, having a high-contrast appearance, being applicable to reflective full-color display, being easy to read, and displaying information at high density; (2) having a thin, flexible structure that allows the user to read the same in a comfortable position with a wide range of illumination conditions to choose from; (3) having a display memory performance that enables the display or storage of information without power, and imposing a low amount of stress on eyes; and (4) being producible at low cost, viewing of multiple media at the same time being easy, and comparison or browsing of information being simple. Since these operational advantages are not achieved by conventional electronic displays, promotion of paperless offices has not been as much as expected, and as a result, this is causing users to print out electrically displayed information in the form of a paper hard copy for reviewing the same. Accordingly, there is demand for display media, as an alternative to paper-based media, to reproduce the various conveniences unique to paper-based documents as mentioned above, in addition to rewritability that helps to save energy and reduce waste.

In recent years, there have been intense studies on rewritable marking techniques, particularly on those utilizing a chemical change caused by heating, including a leuco dye/amphoteric developing-reducing reagent system, a leuco dye/developing-reducing reagent/polar organic compound system, and a leuco dye/long-chain alkyl developing-reducing agent system. These systems using a leuco dye are chemical change-type systems in which a color-switching change is caused by opening or closing of a lactone ring of the leuco dye.

Further, methods utilizing a physical change caused by heating are also being proposed as a method whereby maintainability of an image can be readily achieved, including a polymer/long-chain alkyl low-molecular-weight molecule system, a polymer blend system, and a polymer liquid crystal system. The polymer/long-chain alkyl low-molecular-weight molecule system is a system in which the light-scattering property of the system is controlled by changing the internal gaps thereof by regulating the heating temperature. The polymer blend system is a system in which the light-scattering property of the system is controlled by changing the micro-phase-separation state thereof by regulating the rate of cooling. The polymer liquid crystal system is a system in which the light-scattering property of the system is controlled by changing the crystallinity thereof mainly by regulating the rate of cooling.

Further, there are some studies proposing display media having a liquid crystal layer and a photoconductive layer, in which photoconductive layer migration of free electrons is caused as a result of an internal photoelectric effect, when exposed to light under an electric field. One example of a display medium that is currently being developed is a display medium that has a liquid crystal layer and a photoconductive layer formed between a pair of electrodes. When a voltage is applied to the pair of electrodes, partial pressure is applied to each of the liquid crystal layer and the photoconductive layer. When the photoconductive layer is irradiated with light having a wavelength in a region absorbed by the photoconductive layer (writing light) in this state, the partial pressure applied to the liquid crystal layer is changed in conjunction with the change in the partial pressure applied to the photoconductive layer that is caused in response to the writing light. This change in partial pressure causes a change in the alignment distribution (i.e., optical characteristic distribution) of the liquid crystals, and information according to the writing light is recorded at the liquid crystal layer by this change.

### SUMMARY

According to an aspect of the invention, there is provided a display medium including:

a first electrode;

a second electrode;

a liquid crystal layer provided between the first electrode and the second electrode;

a photoconductive layer provided between the second electrode and the liquid crystal layer, the photoconductive layer absorbing light of a predetermined wavelength used for writing, and thereby exhibiting an electrical characteristic corresponding to the intensity distribution of the light used for writing;

a first light absorption layer provided between the liquid crystal layer and the photoconductive layer, the first light absorption layer absorbing light transmitted through the liquid crystal layer;

a second light absorption layer provided at the side of the second electrode not facing the photoconductive layer, the second light absorption layer allowing transmission of the light used for writing and having an absorbance of 1 or more with respect to light of any wavelength in a range of from 300 nm to 550 nm.

### BRIEF DESCRIPTION OF THE DRAWINGS

Exemplary embodiments of the present invention will be described in detail based on the following figures, wherein:

FIG. 1 is a schematic view of a display device according to an exemplary embodiment of the invention;

FIG. 2A is schematic view of the relationship between the molecular orientation and optical characteristics of a cholesteric liquid crystal in a planar state;

FIG. 2B is schematic view of the relationship between the molecular orientation and optical characteristics of a cholesteric liquid crystal in a focal conic state;

FIG. 2C is schematic view of the relationship between the molecular orientation and optical characteristics of a cholesteric liquid crystal in a homeotropic state;

FIG. 3 is a diagram showing electro-optical response characteristics of a cholesteric liquid crystal;

FIG. 4 is a diagram showing the evaluation results of light fastness of the Examples and the Comparative Examples; and

FIG. 5 is a diagram showing the evaluation results of light fastness of the Examples and the Comparative Examples.

### DETAILED DESCRIPTION

In the following, an exemplary embodiment of a display device and a method of optical writing according to the invention is described with reference to the drawings.

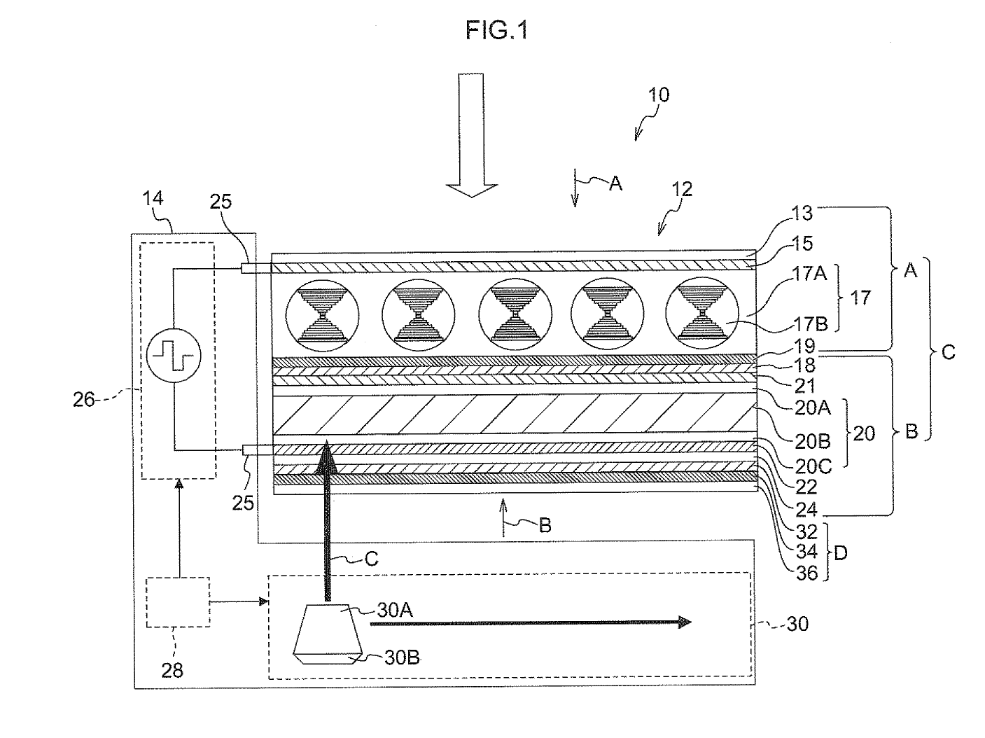

As shown in FIG. 1, the display device 10 according to the present exemplary embodiment includes a display medium 12 and a writing unit 14.

Display medium 12 includes, in the order of from the non-display side (indicated by arrow B in FIG. 1) to the display side (indicated by arrow A in FIG. 1), a substrate 36, a second light absorption layer 34, an adhesive layer 32, a substrate 24, a second electrode 22, a photoconductive layer 20, an isolation layer 21, an adhesive layer 18, a first light absorption layer 19, a liquid crystal layer 17, a first electrode 15, and a substrate 13.

In display medium 12 (details thereof will be described later), the eclectic characteristic distribution in photoconductive layer 20 is changed by applying a voltage between electrodes 15 and 22, and irradiating photoconductive layer 20 with light used for writing (writing light) from the non-display side (indicated by arrow B). Therefore, a partial pressure, which is distributed in accordance with the changes in the electrical characteristic distribution, is applied to liquid crystal layer 17. As a result, cholesteric liquid crystals included in liquid crystal layer 17 change the alignment thereof in response to the applied partial pressure, and an image is formed at liquid crystal layer 17. The writing light has a wavelength in a certain region to which photoconductive layer 20 exhibits sensitivity. The writing light is not particularly limited as long as its wavelength is in a certain region to which photoconductive layer 20 exhibits sensitivity, but the wavelength is preferably in a range of from 600 nm to 800 nm, more preferably from 640 nm to 680 nm, in or the that photoconductive layer 20 exhibits a higher sensitivity.

In FIG. 1, display device 10 corresponds to the display device of the invention, writing unit 14 corresponds to the writing unit of the invention, and display medium 12 corresponds to the display medium of the invention. Further, first electrode 15, second electrode 22, liquid crystal layer 17, photoconductive layer 20, first light absorption layer 19 and second light absorption layer 34 each correspond to the first electrode, second electrode, liquid crystal layer, photoconductive layer, first light absorption layer and second light absorption layer of the invention, respectively.

Substrate 36, substrate 24 and substrate 13 retain other layers among these layers, and support the structure of display medium 12. Substrate 36, substrate 24 and substrate 13 have a shape of a sheet that endures external forces. Substrate 13 located at the display side transmits at least the incident light (light incoming from the display side), and substrates 24 and 36 located at the non-display side (opposite to the display side) transmit at least the writing light.

Substrates 36, 24 and 13 may be omitted, but provision of these substrates to display medium 12 is advantageous in view of retaining the shape or protecting the surface of display medium 12.

A transparent insulating sheet or film may be suitably used for substrates 36, 24 and 13, and exemplary materials thereof include transparent resins such as PET (polyethylene terephthalate), PC (polycarbonate), polyethylene, polystyrene, polyimide, PES (polyethersulfone), and triacetylcellulose, glass, and ceramics. When a transparent resin is used for these substrates, a vapor barrier layer may be additionally provided, as necessary. A light-transmissive plastic substrate is advantageous in view of forming a flexible substrate, carrying out molding in a simple manner, reducing the production cost, or the like.

The thickness of substrates 36, 13 and 24 is preferably in a range of from 50 μm to 500 μm, respectively.

In the present exemplary embodiment, being “insulating” refers to having a volume resistivity of 10¹² Ωcm or more. On the other hand, being “conductive” refers to having a volume resistivity of 10¹⁰ Ωcm or less.

Further, in the present exemplary embodiment, being “transparent” refers to being substantially transmissive (with a transmittance of 80% or more) with respect to the writing light or light in a visible region.

First electrode 15 is formed on substrate 13, which is positioned at the display side, and second electrode 22 is formed on substrate 24, which is positioned at the non-display side.

First and second electrodes 15 and 22 are members that apply a voltage applied from writing unit 14 (details thereof will be described later) to each of the layers positioned between first and second electrodes 15 and 22. Therefore, first and second electrodes 15 and 22 have conductivity, and first electrode 15 positioned at the display side transmits at least the incident light, and second electrode 22 positioned at the non-display side transmits at least the writing light. These first and second electrodes 15 and 22 are preferably transparent.

Exemplary materials for first and second electrodes 15 and 22 include light-transmissive conductive materials, including a film of metal such as indium tin oxide (ITO), gold (Au), aluminum (Al), or copper (Cu), conductive metal oxides such as tin oxide (SnO₂) or zinc oxide (ZnO), or conductive polymers such as polypyrrole. Further, the electrodes may have a structure that serves as both a substrate and an electrode, such as ITO or other various metal plates. The thickness of each of first and second electrodes 15 and 22 is not particularly limited, but may be selected from a range of from 10 nm to 10 μm. First and second electrodes 15 and 22 may be formed by evaporation, sputtering, or the like.

Photoconductive layer 20 is positioned between first and second electrodes 15 and 22, and has an internal photoelectric effect. When the impedance characteristics of the layer change in accordance with the irradiation intensity of the writing light, the layer exhibits an electrical characteristic distribution in response to the intensity distribution of the writing light. Specifically, photoconductive layer 20 of display medium 12 of the present exemplary embodiment has a sensitivity with respect to light having a wavelength region of the writing light, and by absorbing the light of this wavelength region, the layer exhibits an electrical characteristic distribution in response to the intensity distribution of the light.

In the present exemplary embodiment, photoconductive layer 20 has a dual CGL structure that includes, from the display side, a first charge generating layer (CGL) 20A, a charge transporting layer (CTL) 20B, and a second charge generating layer (CGL) 20C.

First charge generating layer 20A and second charge generating layer 20C have a function of generating charges by absorbing the writing light. Therefore, first charge generating layer 20A and second charge generating layer 20C have a structure in which the value of electric resistance changes in a proper manner, in response to the intensity of the writing light. The structure in which “the value of electric resistance properly changes” refers to, when these layers are used in display medium 12, a structure in which the change in the value of electric resistance in response to the change in the intensity of the writing light occurs in the form of a phase change of liquid crystals (change between the planar state and the focal conic state) in liquid crystal layer 17.

Specifically, for example, first charge generating layer 20A and second charge generating layer 20C are each a charge generating layer that absorbs light of a wavelength region of from 600 nm to 800 nm, especially having a high absorbance to light of a wavelength region of from 640 nm to 680 nm, and having the highest absorbance with respect to light of a wavelength of 660 nm (maximum absorbance). In this case, light having a wavelength of 660 nm is used as the writing light.

Specific examples of the material for first and second charge generating layers 20A and 20C include organic materials, such as metal or non-metal phthalocyanine compounds, bis or tris-azo compounds, perylene compounds, squarylium compounds, azulenium compounds, anthrone compounds, pyrylium compounds, polycyclic quinone compounds, indigo pigments, condensed aromatic pigments, xanthene pigments, quinacridone pigments, cyanine dyes, and pyrrolopyrrole dyes. Among these, phthalocyanine crystals such as chlorogallium phthalocyanine, hydroxygallium phthalocyanine, oxytitanyl phthalocyanine, and dichlorotin phthalocyanine are preferably used.

The methods of forming first and second charge generating layers 20A and 20C include a dry method such as vacuum evaporation, sputtering, ion plating or CVD, and a wet method of applying a coating liquid, prepared by dispersing a charge generating material in a binder resin, such as bar coating, spin coating, roll coating, dip coating, casting, blade coating, and spray coating. When the coating liquid is used for the formation of charge generating layer, the concentration of the charge generating material in the coating liquid may be from 1% by weight to 20% by weight, more preferably from 1.5% by weight to 5% by weight.

Exemplary binder resins to be used for the coating liquid include an insulating resin, such as a polymer or a copolymer of polycarbonate resin, polyarylate resin, polyethylene resin, polyurethane resin, polypropylene resin, polyester resin, polyvinyl acetate resin, polyvinyl butyral resin, phenoxy resin, polyamide resin, acrylic resin, methacrylic resin, vinyl chloride, vinyl acetate, or the like. These binder resins may be used alone or in combination of two or more kinds. The solvent for preparing the coating liquid dissolves the binder resin, and examples of such solvents include alcohols such as methanol, ethanol, n-propanol, i-propanol, n-butanol and benzyl alcohol, ketones such as acetone, methyl ethyl ketone and cyclohexanone, amides such as dimethylformamide and dimethylacetoamide, sulfoxides such as dimethylsulfoxide, linear or cyclic ethers such as tetrahydrofuran, dioxane, diethylether, methyl cellosolve and ethyl cellosolve, esters such as methyl acetate, ethyl acetate and n-butyl acetate, aliphatic halogenated hydrocarbons such as methylene chloride, chloroform, carbon tetrachloride, chloroethylene and trichloroethylene, mineral oils such as ligroin, aromatic hydrocarbons such as benzene, toluene and xylene, and aromatic halogenated hydrocarbons such as chlorobenzene and dichlorobenzene.

The thickness of first and second charge generating layers 20A and 20C may be from 10 nm to 1 μm, preferably from 20 nm to 500 nm respectively.

Charge transporting layer 20B is a layer into which the charges generated in first charge generating layer 20A or second charge generating layer 20C are injected, and the injected charges drift in a direction of the applied electric field. Typically, charge transporting layer 20B has a thickness of several ten times the thickness of first charge generating layer 20A or second charge generating layer 20C. Therefore, the capacity of charge transporting layer 20B, the dark current of charge transporting layer 20B, and the current that runs in charge transporting layer 30B are main factors that determine the light-dark impedance of the whole structure of photoconductive layer 20.

Charge transporting layer 20B includes a charge transporting material, and is preferably a layer in which the injection of holes from first charge generating layer 20A or second charge generating layer 20C occurs in a highly efficient manner (i.e., the ion potential of charge transporting layer 20B is preferably close to that of first and second charge generating layers 20A and 20C), and the injected holes move by hopping at high speed. In order to increase the impedance of photoconductive layer 20 when the layer is not irradiated with the writing light, the dark current due to heat carriers is preferably lower.

Exemplary charge transporting materials used in charge transporting layer 20B include hole transporting materials such as diamine compounds, carbazole compounds, triazole compounds, oxadiazole compounds, imidazole compounds, pyrazoline compounds, benzylamino hydrazone compounds, quinoline hydrazone compounds, stilbene compounds, triphenylamine compounds, triphenylmethane compounds, nitrofluorenone compounds, trinitrofluorenone compounds, and benzidine compounds; and electron transporting materials such as quinone compounds, tetracyanoquinodimethane compounds, fluorenone compounds, xanthone compounds, benzophenone compounds, and stilbene compounds. Among these, diamine compounds having a high sensitivity and a high hole-transporting property are preferred. In the present exemplary embodiment, charge transporting layer 20B is described as a hole transporting layer, but the layer may be an electron transporting layer.

It is assumed that the light fastness of photoconductive layer 20 can be improved by selecting an appropriate combination of the charge transporting material included in charge transporting layer 20B, and the charge generating material included in first and second charge generating layers 20A and 20C.

Specifically, a combination of a phthalocyanine compound as the charge generating material included in first and second charge generating layers 20A and 20C and a stilbene compound as the charge transporting material included in charge transporting layer 20B is preferred in view of improving the light fastness.

The phthalocyanine compound preferably used as the charge generating material in combination with the stilbene compound as the charge transporting material in view of improving the light fastness is preferably at least one selected from the following group.

(1) a chlorogallium phthalocyanine having a diffraction peak in an X-ray diffraction spectrum at Bragg angles) (2θ±0.2°) of at least 7.4°, 16.6°, 25.5° and 28.3°;

(2) a chlorogallium phthalocyanine having a diffraction peak in an X-ray diffraction spectrum at Bragg angles) (2θ±0.2°) of at least 6.8°, 17.3°, 23.6° and 26.9°;

(3) a chlorogallium phthalocyanine having a diffraction peak in an X-ray diffraction spectrum at Bragg angles) (2θ±0.2°) of at least a position from 8.7° to 9.2°, 17.6°, 24.0°, 27.4° and 28.8°;

(4) a hydroxygallium phthalocyanine having a diffraction peak in an X-ray diffraction spectrum at Bragg angles) (2θ±0.2°) of at least 7.5°, 9.9°, 12.5°, 16.3°, 18.6°, 25.1° and 28.3°;

(5) a hydroxygallium phthalocyanine having a diffraction peak in an X-ray diffraction spectrum at Bragg angles) (2θ±0.2°) of at least 7.7°, 16.5°, 25.1°, and 26.6°;

(6) a hydroxygallium phthalocyanine having a diffraction peak in an X-ray diffraction spectrum at Bragg angles) (2θ±0.2°) of at least 7.9°, 16.5°, 24.4°, and 27.6°;

(7) a hydroxygallium phthalocyanine having a diffraction peak in an X-ray diffraction spectrum at Bragg angles) (2θ±0.2°) of at least 7.0°, 7.5°, 10.5°, 11.7°, 12.7°, 17.3°, 18.1°, 24.5°, 26.2°, and 27.1°;

(8) a hydroxygallium phthalocyanine having a diffraction peak in an X-ray diffraction spectrum at Bragg angles) (2θ±0.2°) of at least 6.8°, 12.8°, 15.8° and 26.0°;

(9) a hydroxygallium phthalocyanine having a diffraction peak in an X-ray diffraction spectrum at Bragg angles) (2θ±0.2°) of at least 7.4°, 9.9°, 25.0°, 26.2° and 28.2°;

(10) a titanyl phthalocyanine having a diffraction peak in an X-ray diffraction spectrum at Bragg angles) (2θ±0.2°) of at least 9.3° and 26.3°; and

(11) a titanyl phthalocyanine having a diffraction peak in an X-ray diffraction spectrum at Bragg angles) (2θ±0.2°) of at least 9.5°, 9.7°, 11.7°, 15.0°, 23.5°, 24.1° and 27.3°.

One example of the stilbene compound used as the charge transporting compound is a stilbene compound represented by the following formula (II):

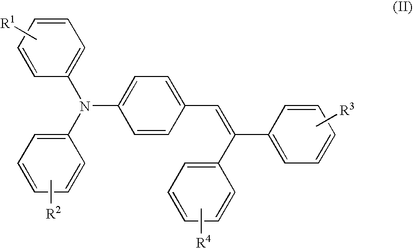

The stilbene compound represented by formula (II) is preferably a stilbene compound represented by the following formula (I), from the viewpoint of improving light fastness by combining the same with the aforementioned phthalocyanine.

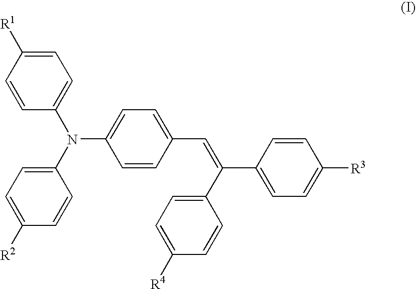

In the above formula (II) and formula (I), R¹, R², R³ and R⁴ each independently represent a hydrogen atom, a methyl group, or an ethyl group.

Among the stilbene compounds represented by formula (I), preferred examples thereof to be combined with the phthalocyanine compound in view of improving light fastness include the compounds represented by the following formulae (I-1), (I-2) and (I-3).

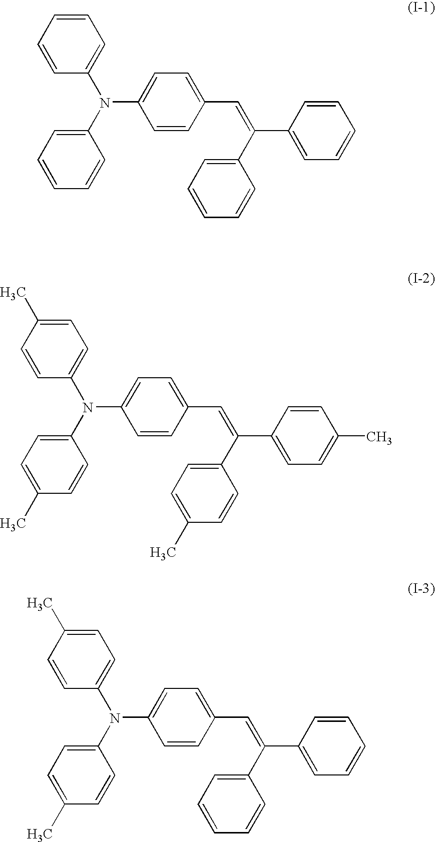

Examples of the binder resin included in charge transporting layer 20B include polycarbonate resin, polyester resin, methacrylic resin, acrylic resin, polyvinyl chloride resin, polyvinylidene chloride resin, polystyrene rein, polyvinyl acetate resin, styrene-butadiene copolymer, vinylidene chloride-acrylonitrile copolymer, vinylidene chloride-vinyl acetate copolymer, vinyl chloride-vinyl acetate-maleic anhydride copolymer, silicone resin, silicone-alkyd resin, phenol-formaldehyde resin, and styrene-alkyd resin. In particular, a polycarbonate resin, which exhibits a favorable charge transporting property and an excellent balance among strength, flexibility and transparency, is suitable used as the binder resin for the charge transporting layer.

The mixing ratio of the charge transporting material to the binder resin in charge transporting layer 20B (charge transporting material/binder resin) may be from 1/10 to 10/1, preferably from 3/7 to 7/3.

The methods of forming charge transporting layer 20B include a dry method such as vacuum evaporation or sputtering, and a wet method using a solvent, such as spin coating, dipping, blade coating, and roll coating. Exemplary solvents include ordinary organic solvents, including aromatic hydrocarbons such as benzene, toluene, xylene and chlorobenzene, ketones such as acetone and 2-butanone, halogenated aliphatic hydrocarbons such as methylene chloride, chloroform and ethylene chloride, and linear or cyclic ethers such as tetrahydrofuran and ethyl ether. These solvents may be used alone or in combination of two or more kinds. The concentration of the charge transporting material in the coating solution for forming charge transporting layer 20B may be from 5% by weight to 50% by weight, preferably from 10% by weight to 20% by weight.

The thickness of charge transporting layer 20B may be from 1 μm to 100 μm, preferably from 3 μm to 20 μm.

In the present exemplary embodiment, photoconductive layer 20 includes first charge generating layer 20A, charge transporting layer 20B and second charge generating 20C formed in this order, but the configuration of photoconductive layer 20 is not particularly limited thereto as long as the electrical characteristics of the layer change upon exposure to the writing light.

Liquid crystal layer 17 has a function of modulating the state of being reflective or transmissive with respect to the incident light in response to application of an electric field, by utilizing the changes in the state of light interference of cholesteric (chiral nematic) liquid crystals, and has a function of maintaining the selected state with no electric field applied. Further, liquid crystal layer 17 preferably has a structure that does not deform by bending or applying pressure.

In the present exemplary embodiment, liquid crystal layer 17 has a structure of free-standing liquid crystal complex, formed from cholesteric liquid crystals and a transparent resin. Specifically, liquid crystal layer 17 used in the present exemplary embodiment is a self-standing liquid crystal layer that can maintain its structure as a complex without a spacer or the like. In the present exemplary embodiment, liquid crystal layer 17 is formed by dispersing cholesteric liquid crystals 17B in a polymer matrix (transparent resin) 11. The structure of liquid crystal layer 17 is not limited to the above, and may be a layer formed only from liquid crystals.

Cholesteric liquid crystals 17B have a function of modulating the state of being reflective or transmissive with respect to light of a specific color included in the incident light. The molecules of cholesteric liquid crystals 17B are aligned in a helically twisted manner, and reflect a specific component of the incident light incoming from the helical axis direction, depending on the helical pitch of the liquid crystals. These liquid crystals change the alignment thereof when an electric field is applied, and change the state of reflection. Cholesteric liquid crystals 17B exhibit an excellent display property due to a high degree of reflectivity with respect to the applied voltage, as well as a memory property, and are therefore particularly advantageously used in display medium 12 of the present exemplary embodiment. When used in a self-standing liquid crystal complex, cholesteric liquid crystals 17B preferably have a uniform drop size, and are preferably positioned in a single layer with high density.

Usable examples of cholesteric liquid crystals 17B include those prepared by adding a chiral agent formed from an optically activated compound, such as a cholesterol derivative or a 2-methylbuthyl group, to known nematie liquid crystals such as those of cyano biphenyl-type, phenylcyclohexyl-type, phenylbenzoate-type, cyclohexylbenzoate-type, azomethine-type, azobenzene-type, pyrimidine-type, dioxane-type, cyclohexylcyclohexane-type, stilbene-type, tolan-type. Further examples include cholesteric liquid crystals having an asymmetrical carbon and the composition thereof exhibits an optical activity by itself. The cholesteric liquid crystals may be a single kind of compound, or may be a combination of two or more compounds that do not exhibit liquid crytallinity when used separately.

Examples of the structure of a self-standing liquid crystal complex formed from cholesteric liquid crystals 17B and polymer matrix 17A include a PNLC (Polymer Network Liquid Crystal) structure, in which a resin having a net-like structure is contained in the continuous phase of cholesteric liquid crystals, and a PDLC (Polymer Dispersed Liquid Crystal) structure, in which droplets of cholesteric liquid crystals are dispersed in the polymer skeleton (including those having a microcapsule structure). By forming cholesteric liquid crystals having the PNLC structure or the PDLC structure, an anchoring effect is created at an interface of the cholesteric liquid crystals and the polymer, thereby making it more stable to maintain a planar or focal conic state while no electric field is applied.

The PNLC structure or the PDLC structure may be obtained by a known method of causing phase separation of a polymer and liquid crystals, and examples thereof include an interface deposition method such as a phase separation method, a solvent evaporation method, a melting dispersion cooling method, a spray drying method, a pan coating method, an air-suspension coating method, an interface reaction method such as an interface polymerization method, an in-situ polymerization method, and an interface reaction method such as a solvent curing coating method. Examples of the material for the shell for encapsulating cholesteric liquid crystals 17B include gelatin, gelatin-gum Arabic, polyvinyl alcohol, polyamide, polyurethane/polyurea, and urea formaldehyde.

Polymer matrix 17A retains cholesteric liquid crystals 17B therein, and has a function of suppressing the movement of liquid crystals caused by the deformation of display medium 12 (changes in an image). A polymer material that does not dissolve in a liquid crystal material or is not compatible with the liquid crystals is preferably used for polymer matrix 17A. Further, the material preferably has a strength that is enough to withstand external forces, and a high degree of transmission at least with respect to the incident light and the writing light.

Examples of the material that may be used for polymer matrix 17A include resins such as epoxy resin, acrylic resin, urethane resin, polyester resin, polyamide resin, olefin resin, vinyl resin, phenol resin, urea resin, glass, and ceramics.

Cholesteric liquid crystals 17B are in a state of any of planar, focal conic, or homeotropic.

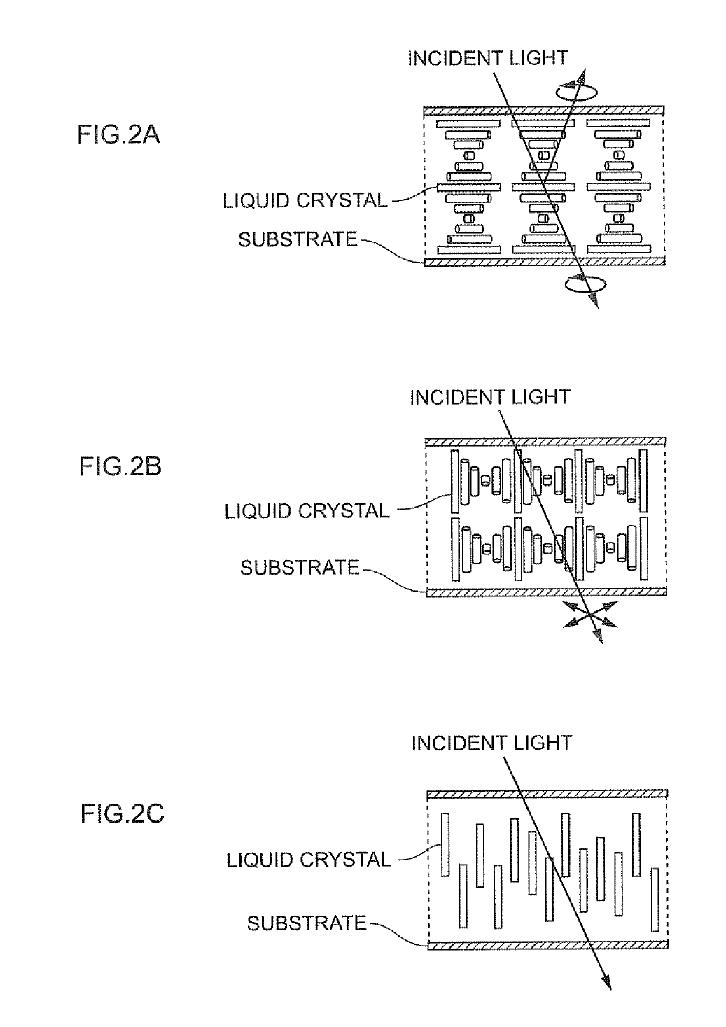

In a planar state, as shown in FIG. 2A, the helical axis of cholesteric liquid crystals is aligned vertical to the cell surface, and the incident light is selectively reflected as mentioned above.

In a focal conic state, as shown in FIG. 2B, the helical axis of cholesteric liquid crystals is aligned substantially parallel with the cell surface, and the incoming light is transmitted with a slight amount of forward scattering.

In a homeotropic state, as shown in FIG. 2C, the helical structure of cholesteric liquid crystals is untwisted and the liquid director is aligned in a direction of an electric field, and the incident light is almost completely transmitted.

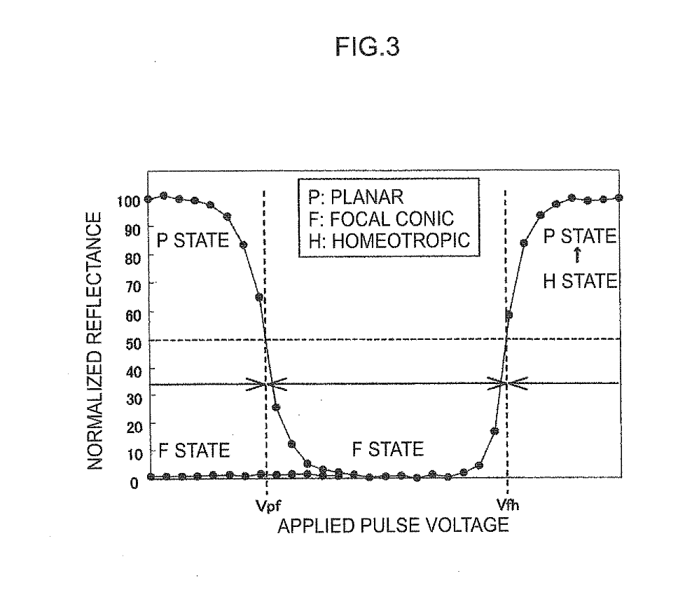

Among the above three states, the planar state and the focal conic state remain bistable while no electric field is applied. Therefore, the state of alignment of cholesteric liquid crystals is not determined depending only on the voltage applied to the liquid crystal layer. Accordingly, the liquid crystal has an electro-optical response characteristic in which, in the planar state of an early stage, the liquid crystal changes in the order of from a planar state, a focal conic state and a homeotropic state; and while in the focal conic state of an early stage, the liquid crystal changes from a focal conic state into a homeotropic state as the applied voltage increases (FIG. 3).

On the other hand, the liquid crystals exhibit an electro-optical response characteristic in which, when the voltage applied to liquid crystal layer 17 is rapidly decreased to zero, the liquid crystals in a planar state or a focal conic state remain the same, while the liquid crystals in a homeotropic state change into a planar state (FIG. 3).

Accordingly, when the voltage is applied to liquid crystal layer 17 and then the application is stopped, liquid crystal layer 17 shows a switching behavior having a bathtub shape as shown in FIG. 3, when the applied voltage is rapidly decreased to zero.

Specifically, when the voltage applied to liquid crystal layer 17 before stopping the application is Vfh (upper threshold voltage) or more, the cholesteric liquid crystals change from a homeotropic state to a planar state after stopping the application (selectively reflective state); when the voltage is between Vpf (lower threshold voltage) and Vfh, the cholesteric liquid crystals change to a focal conic state (transmissive); and when the voltage is Vpf or less, the liquid crystals maintain the state prior to the application of voltage, i.e., either a planar state (selectively reflective state) or a focal conic state (transmissive state). By employing these changes in the states of liquid crystals, display medium 12 displays an image on liquid crystal layer 17.

In FIG. 3, the vertical axis indicates the normalized reflectance in which the maximum reflectance and the minimum reflectance are determined as 100 and 1, respectively. Since there are transition ranges between the planar, focal conic and homeotropic states, it is determined as a selectively reflective state when the normalized reflectance is 50 or more, and it is determined as a transmissive state when normalized reflectance is less than 50. Further, the threshold voltage at which the liquid crystals change from a planar state to a focal conic state is determined as the lower threshold voltage (Vpf), and the threshold voltage at which the liquid crystals change from a focal conic state to a homeotropic state is determined as the upper threshold voltage (Vfh).

The methods of forming liquid crystal layer 17 include a printing method such as screen printing, relief printing, gravure printing, planographic printing, and flexo printing, and an application method such as spin coating, bar coating, dip coating, roll coating, knife coating, and die coating. Liquid crystal layer 17 may not be in contact with first electrode 15, as long as it is positioned between first electrode 15 and photoconductive layer 20 (and first light absorption layer 19). Further, a functional layer may be positioned between first electrode 15 and liquid crystal layer 17, such as an anchor coat layer for promoting the adhesiveness, or an insulating layer for preventing the short circuit, as long as the effect of these layers on the driving voltage is negligible.

In display medium 12, an isolation layer 21, an adhesive layer 18, and a first light absorption layer 19 are positioned between photoconductive layer 20 and liquid crystal layer 17, in the order of from photoconductive layer 20 to liquid crystal layer 17.

Adhesive layer 18 may be provided for the purpose of absorbing the surface irregularities of resin layers or serving as an adhesive between these layers, when bonding the layers each formed on the inner side of the upper and lower substrates together. Adhesive layer 18 is formed from a polymer material having a low glass transition temperature that can bond the layers by applying heat or pressure. In the present exemplary embodiment, adhesive layer 18 is preferably formed from an insulating material.

Examples of the preferred material for adhesive layer 18 include known adhesives such as acrylate adhesives, urethane adhesives, cyanoacrylate adhesives, silicone adhesives, isoprene adhesives, and ethylene-vinyl acetate copolymer adhesives. The type of the adhesive is not particularly limited, and may be selected from two-liquid curing type, thereto-curing type, moisture-curing type, ultraviolet-curing type, hot-melt type, pressure-sensitive type, and the like.

Since adhesive layer 18 may damage photoconductive layer 20 depending on the type or the formation method thereof, isolation layer 21 may be formed between adhesive layer 18 and photoconductive layer 20.

Isolation layer 21 may be formed from a resin soluble in water, a resin soluble in water and an organic solvent, or an aqueous emulsion-dispersion-latex. Examples of the resin soluble in water include an alkyl cellulose such as polyvinyl alcohol, methyl cellulose and ethyl cellulose, carboxymethyl cellulose, hydroxymethyl cellulose, hydroxypropyl cellulose, polyethylene imine, polyacrylic acid, polyacrylic acid salt, polyacrylate such as polyacrylic amide, polyethylene oxide, polyvinyl pyrrolidone, starch, casein, glue, gelatin, gum Arabic, guar gum, alginate, locust beam gum, carrageenan, tamarind, pectin, urethane resins having a hydrophilic group such as a hydroxyl group, a carboxyl group, a sulfonic group or an amino group, epoxy resins, and acrylic resins. Examples of the resin soluble in water and an organic solvent include ethylene-vinyl acetate copolymer, polyacrylamide, polyethylene imine, polyvinyl pyrrolidone, polyglycerin, and other resins soluble in water and an organic solvent. Examples of the aqueous emulsion-dispersion-latex include ethylene-vinyl acetate copolymer, ethylene-vinyl chloride copolymer, polyurethane, polyacrylate, styrene-butadiene rubber, and nitrile-butadiene rubber. Since one purpose of providing isolation layer 21 is to prevent the dispersion of a low-molecular non-aqueous component or an organic solvent included in the adhesive, the layer is preferably formed from a resin that is soluble in water but not swellable with an organic solvent.

First light absorption layer 19 is provided between liquid crystal layer 17 and photoconductive layer 20 (more specifically, between liquid crystal layer 17 and adhesive layer 18).

First light absorption layer 19 is provided for the purpose of suppressing the degradation in image quality, by optically separating the writing light from the light used for reading to prevent malfunctions caused by the mutual interference thereof, while optically separating the incident light incoming from the non-display side of display medium 12 (substrate 36 side) from the image displayed on liquid crystal layer 17. The light used for reading is light transmitted through liquid crystal layer 17 from the display side of display medium 12 (substrate 13 side) to first light absorption layer 19, such as sunlight or room light. Therefore, first light absorption layer 19 needs to have a light-shielding property of absorbing at least the light transmitted through liquid crystal layer 17.

First light absorption layer 19 preferably has an absorbance of 1 or more, more preferably 2 or more, with respect to light of any wavelength of from 400 nm to 700 nm. Further, first light absorption layer 19 preferably has an absorbance of 1 or more, more preferably 2 or more, with respect to light of any visible wavelength.

When first light absorption layer 19 has an absorbance of 1 or more with respect to light of at least any wavelength of from 400 nm to 700 nm, it is assumed that malfunctions of photoconductive layer 20 caused by light transmitted through liquid crystal layer 17 can be prevented.

The material for first light absorption layer 19 is not particularly limited as long as it has a black color, and examples thereof include resin colorants such as a resin in which a pigment is dispersed, a resin in which a dye is dissolved, or a resin colored with a dye. Examples of the pigment include inorganic pigments such as carbon black, aniline black, and chromium oxide. Examples of the dye include nitroso dye, nitro dye, stilbene azo dye, diphenylmethane dye, triphenyl methane dye, xanthene dye, quinoline dye, polymethine dye, thiazole dye, indophenol dye, azine dye, oxazine dye, thiazine dye, sulfur dye, aminoketone dye, anthraquinone dye, and indigoid dye.

A water-soluble resin having a polymerization degree of from 1,000 to 3,000 may be used as the resin in which the pigment or dye is dispersed or dissolved, so that the film formed by applying the same has a film-forming property. Examples of the water-soluble resin include fully or partially saponified polyvinyl alcohol, water-soluble polyvinyl acetal, water-soluble polyvinylformal, polyacrylamide, polyvinyl pyrrolidone, poly(meth)acrylic acid, water-soluble poly(meth)acrylic acid copolymer, polyalkylene oxide, water-soluble polyester, polyethylene glycol, and water-soluble maleic acid resin. Among these, polyvinyl alcohol and derivatives of polyvinyl alcohol such as water-soluble polyvinyl acetal and water-soluble polyvinyl formal are particularly preferred.

The methods of forming first light absorption layer 19 include a printing method such as screen printing, relief printing, gravure printing, planographic printing, and flexo printing, and an application method such as spin coating, bar coating, dip coating, roll coating, knife coating, and die coating.

The thickness of first light absorption layer 19 may be from 1 μm to 10 μm. Further, first light absorption layer 19 is preferably formed from an insulating material.

On the outer side (non-display side) of second electrode 22, an adhesive layer 32, a second light absorption layer 34 and substrate 36 are formed, in the order of from substrate 24 to the non-display side.

Adhesive layer 32 has a function of bonding substrate 24 with second light absorption layer 34. The material, structure or characteristics of adhesive layer 32 may be the same as that of adhesive layer 18.

Second light absorption layer 34 is provided at the side of second electrode 22 not facing photoconductive layer 20. Specifically, second light absorption layer 34 is provided on the outer side of second electrode 22 (non-display side).

Second light absorption layer 34 is provided for the purpose of absorbing light transmitted into display medium 12 from the non-display side (indicated by arrow B in FIG. 1), having a wavelength other than that used for writing.

Therefore, second absorption layer 34 transmits at least the writing light (at a transmittance of 80% or more), while blocks the light not used for the writing. In the present exemplary embodiment, second light absorption layer 34 has an absorbance of 1 or more with respect to light of any wavelength of from 300 nm to 550 nm, which is shorter than that of light used for writing, as a light shielding property.

As mentioned above, second light absorption layer 34 transmits the writing light and has an absorbance of 1 or more, more preferably having an absorbance of 2 or more, and further preferably having an absorbance of 3 or more, with respect to light of any wavelength of from 300 nm to 550 nm.

Yet more preferably, second light absorption layer 34 has an absorbance of 1 or more, more preferably having an absorbance of 2 or more, and further preferably having an absorbance of 3 or more, with respect to light of any wavelength of from 300 nm to less than 600 nm.

Since second light absorption layer 34 transmits the writing light and has an absorbance of 1 or more with respect to light of any wavelength of from 300 nm to 550 nm, it is assumed that irradiation of photoconductive layer 20 with light of a wavelength other than that of the writing light can be suppressed.

Second light absorption layer 34 may be formed from a resin in which a pigment is dispersed, for example, by applying a coating solution including a non-water-soluble resin in which a pigment is dispersed, and drying the same.

The pigment used for second light absorption layer 34 is not particularly limited as long as it has the aforementioned light shield property with respect to light of a wavelength of from 300 nm to 550 nm, preferably from 300 nm to less than 600 nm, and may a red pigment (such as P.R. 254) or a yellow pigment (such as P.Y. 42 or P.Y. 139) typically used. The pigment for second light absorption layer 34 may be used alone or in combination of two or more kinds.

The resin used for second light absorption layer 34 is preferably a non-water-soluble resin in view of favorable production suitability or adhesiveness to substrate 36, and examples thereof include alkyd (phthalic acid) resin, vinyl chloride resin, vinylidene chloride resin, unsaturated polyester resin, melamine resin, urea resin, phenol resin, acrylic resin, polyurethane resin, vinyl acetate resin, epoxy resin, cellulose, silicone resin, and butyral resin. These resins may include a curing agent such as polyisocyanate, or a thickening agent, as an additive.

The methods of forming second light absorption layer 34 include a printing method such as screen printing, relief printing, gravure printing, planographic printing, and flexo printing, and an application method such as spin coating, bar coating, dip coating, roll coating, knife coating, and die coating. In the application method, a coating solution prepared by dispersing or dissolving the aforementioned pigment in a suitable solvent together with the aforementioned resin may be used.

The thickness of second light absorption layer 34 is not particularly limited as long as the portability or flexibility of display medium 12 is not impaired, and may be from 1 μm to 10 μm, for example.

Display medium 12 according to the present exemplary embodiment may be produced in accordance with the following process, for example.

A layer structure A is produced by forming, on first electrode formed on substrate 13, liquid crystal layer 17 and first light absorption layer 19 in this order.

On the other hand, photoconductive layer 20 is produced by forming, on second electrodes 22 formed on substrate 24, second charge generating layer 20C, charge transporting layer 20B and first charge generating layer 20A in this order. Then, a layer structure B is produced by forming, on photoconductive layer 20, isolation layer 21 and adhesive layer 18 in this order.

A layer structure C is produced by layering the layer structure A and layer structure B so that first light absorption layer 19 of layer structure A contacts adhesive layer 18 in layer structure B.

Further, a layer structure D is produced by forming, on substrate 36, second light absorption layer 34 and adhesive layer 32, and this adhesive layer 32 of layer structure D is bonded to substrate 24 of layer structure C. In this way, display medium 12 may be obtained.

Details of each layer and the formation method thereof as mentioned above are also applicable to the above process.

In display medium 12 obtained by the above process, an image is displayed in liquid crystal layer 17 in the following manner.

Specifically, a driving voltage is applied between first electrode 15 and second electrode 22, and photoconductive layer 20 is irradiated with the writing light from the non-display side. At this time, liquid crystal layer 17 is positioned between the electrodes. Partial pressure is applied to each of liquid crystal layer 17, first light absorption layer 19, adhesive layer 18, isolation layer 21, and photoconductive layer 20. Further, the electric resistance of photoconductive layer 20 changes in response to the intensity of the writing light, and exhibits an electrical characteristic in response to the intensity distribution of the writing light. Therefore, the greater the intensity of the writing light is, the lower the electric resistance of photoconductive layer 20 at a region irradiated with the writing light is, thereby reducing the partial pressure applied to liquid crystal layer 17 in this region. On the other hand, the smaller the intensity of the writing light is, the higher the electric resistance of photoconductive layer 20 is, thereby increasing the partial pressure applied to liquid crystal layer 17 in this region. The change in partial pressure causes changes in the alignment of liquid crystals in liquid crystal layer 17, which results in changes in reflectivity. Since the cholesteric liquid crystals used in liquid crystal layer 17 exhibit a memory property as mentioned above, the difference in reflectivity remains at liquid crystal layer 17 in the form of an exposed image even after stopping the irradiation with the writing light and application of the driving voltage thereto. Through this system, images are displayed on liquid crystal layer 17 of display medium 12.

In display medium 12 according to the present exemplary embodiment, second light absorption layer 34 is provided upstream of photoconductive layer 20 in the direction in which the writing light is incoming. Second light absorption layer 34 transmits the writing light, and exhibits a light shield property of absorbance of 1 or more with respect to light of any wavelength of from 300 nm to 550 nm. Therefore, it is assumed that the arrival of light of wavelength not used for the writing, such as fluorescent light, at photoconductive layer 20 from the non-display side is suppressed, and deterioration of photoconductive layer 20 due to light from outside can be suppressed, thereby providing display medium 12 having an excellent light fastness.

Further, as mentioned above, when the charge generating material included in first charge generating layer 20A and second charge generating layer 20C is a phthalocyanine compound and the charge transporting material included in charge transporting layer 20B is a stilbene compound, it is assumed that the light fastness of photoconductive layer 20 can be further improved.

When photoconductive layer 20 is deteriorated due to light from outside, changes in the electrical characteristic distribution may decrease as compared with the case when photoconductive layer 20 is not deteriorated, even when the layer is irradiated with the writing light of the same intensity. As a result, it is assumed that the display characteristics of liquid crystal layer 17 may deteriorate.

Further, the “display characteristics” of liquid crystal layer 17 exhibit the responsibility thereof to the changes in reflectivity caused by application of a voltage. Specifically, the “state in which deterioration of display characteristics of liquid crystal layer 17 is suppressed” refers to a state in which the changes in reflectivity are visually observed as a difference in color, when applying a voltage of a specific value between the electrodes of the display medium and irradiating the same with writing light of a specific intensity. Further, the state in which the display characteristics of liquid crystal layer 17 are deteriorated refers to a state in which the changes in reflectivity are not visually observed as the changes in color, even when application of a voltage of the same value and irradiation with writing light of the same intensity are conducted.

The value of the voltage to be applied may be set such that cholesteric liquid crystals 17B do not change the state between focal conic and planar (or homeotropic) when not irradiated with light, while these changes occur when irradiated with light.

In the following, details of display device 10 equipped with display medium 12 according to the present exemplary embodiment will be described.

Writing unit 14 is a unit that writes an image on display medium 12, and includes an exposure unit 30 that scan-exposes display medium 12 with the writing light; a voltage application unit 26 that applies a voltage between first electrode 15 and second electrode 22 of display medium 12; and a control unit 28 that is electrically connected to exposure unit 30 and voltage application unit 26, and controls these units.

Exposure unit 39 includes a light source 30A that irradiates photoconductive layer 20 with the writing light from the non-display side of display medium 12 through second light absorption layer 34; and a driving unit 30B that scan-drives light source 30A over the whole region of display medium 12.

When light source 30A is not scan-driven, the region of photoconductive layer 20 to be irradiated with the writing light of a near-infrared region from light source 30A is preferably smaller than a region corresponding to each pixel of an image to be displayed on liquid crystal layer 17. By adjusting the state of exposure/non-exposure by light source 30A, and by scan-driving the same by driving unit 30B, the state of exposure/non-exposure of the writing light can be adjusted to correspond to each pixel of the image to be displayed on liquid crystal layer 17.

Light source 30A is not particularly limited as long as it emits writing light of a desired spectrum, intensity, space frequency, or the like, toward photoconductive layer 20 of display medium 12 in accordance with the signals inputted from control unit 28.

Further, the writing light emitted from light source 30A preferably has a high level of energy in a wavelength region corresponding to photoconductive layer 20.

Voltage application unit 26 is not particularly limited as long as it applies a voltage between first electrode 15 and second electrode 22 in accordance with the signals inputted from control unit 28, with a polarity and a value corresponding to the inputted signals, for a certain period according to the inputted signals. Examples of voltage application unit 26 include a bipolar high-pressure amplifier.

Voltage application unit 26 applies a voltage between first electrode 15 and second electrode 22, via a contact terminal 25. Contact terminal 25 is a member that electrically connects voltage application unit 26 to first and second electrodes 15 and 22 of display medium 12, and has a high conductivity and a small contact resistance between voltage application unit 26 and electrodes 15 and 22. Contact terminal 25 is preferably detachable from at least one of voltage application unit 26 or electrodes 15 and 22, so that display medium 12 can be separated from writing unit 14.

Control unit 28 includes a CPU (Central Processing Unit, not shown), a ROM (Read Only Memory, not shown), a RAM (Random Access Memory, not shown) or the like, and controls the components of writing unit 14 in accordance with the programs stored in the ROM, and controls voltage application unit 26 and exposure unit 30 so that an image is displayed on display medium 12 in response to image data obtained from an external source with or without wires.

Display medium 12 may be integrated with writing unit 14, or may be separable from writing unit 14. When display medium 12 is separable from writing unit 14, for example, display medium 12 may have a structure in which, when display medium 12 is attached to a slot or the like (not shown), first and second electrodes 15 and 22 are connected to voltage application unit 26 so that a voltage can be applied thereto, and display medium 12 can be irradiated by exposure unit 30 with the writing light from the non-display side (light absorption layer 19 side) toward second charge generating layer 20C of photoconductive layer 20.

As mentioned above, when display medium 12 is separable from writing unit 14, display medium 12 can be easily carried around alone to use for browsing, circulation or distribution. Further, by attaching display medium 12 to a slot or the like of writing unit 14 again, rewriting or deletion of the images can be carried out.

In display device 10 having the above configuration, writing of an image is carried out by controlling voltage application unit 25 and exposure unit 30 by control unit 28, in accordance with the data of the image to be displayed. Specifically, control unit 28 controls voltage application unit 26 to apply a voltage between first and second electrodes 15 and 22, and controls exposure unit 30 to drive driving unit 30B to move light source 20A to a position corresponding to each pixel of the image to be displayed At this position, writing light is emitted from light source 30A to display medium 12 from the non-display side thereof. In this way, an image is displayed on display medium 12.

Display medium 12 has second light absorption layer 34 upstream of photoconductive layer 20 in a direction of irradiation of the writing light. Therefore, photoconductive layer 20 is irradiated with the writing light through second light absorption layer 34 by exposure unit 30. Further, light such as fluorescent light is blocked by second light absorption layer 34, and prevented from reaching photoconductive layer 20. As a result, it is assumed that deterioration of photoconductive layer 20 due to external light can be suppressed and display medium 12 having an excellent light fastness can be provided.

Moreover, as mentioned above, when the charge generating material included in first charge generating layer 20A and second charge generating layer 20C is a phthalocyanine compound and the charge transporting material included in charge transporting layer 20B is a stilbene compound, light fastness of photoconductive layer 20 can be further improved and deterioration thereof due to external light can be further suppressed, and it is assumed that display medium 12 having a further improved light fastness can be provided.

### EXAMPLES

In the following, the invention will be described in further detail with reference to the Examples. However, the invention is not limited thereto. In the Examples, “parts” and “%” refer to “parts by weight” and “% by weight”, respectively.

(Preparation of Second Light Absorption Layer)

—Second Light Absorption Layer 1—

A mixed pigment (P.R 254, P.Y. 139 and P.Y. 42, mixed at a weight ratio of 36:10:54) and an acrylic resin as a binder resin are dispersed in propyl acetate at a weight ratio of 2:3 (mixed pigment:binder resin), thereby preparing a 20-weight % propyl acetate solution (coating solution F-1). This coating solution F-1 is applied on a PET substrate (manufactured by Toray Industries, Inc., thickness: 125 μm) as substrate 36 using an applicator having a gap of 50 μM, and then dried. Second light absorption layer 1 having a thickness of 6.5 μm is thus prepared.

—Second Light Absorption Layer 2—

Second light absorption layer 2 having a thickness of 8.3 μm is prepared in a similar manner to second light absorption layer 1, but using an applicator having a gap of 75 μm instead of the applicator having a gap of 50 μm.

—Second Light Absorption Layer 3—

A mixed pigment (zinc oxide fine particles and P.Y. 83, mixed at a weight ratio of 3:2) and an acrylic resin as a binder resin are dispersed in methyl ethyl ketone (MEK) at a weight ratio of 2:3 (mixed pigment:binder resin), thereby preparing a 20-weight % MEK solution (coating solution F-2). This coating solution F-2 is applied on a PET substrate (manufactured by Toray Industries, Inc., thickness: 125 μm) as substrate 36 using an applicator having a gap of 50 μm, and then dried. Second light absorption layer 3 having a thickness of 5.5 μm is thus prepared.

—Second Light Absorption Layer 4—

Second light absorption layer 4 having a thickness of 9.3 μm is prepared in a similar manner to second light absorption layer 3, but using an applicator having a gap of 75 μm instead of the applicator having a gap of 50 μm.

—Comparative Light Absorption Layer 1—

A mixed pigment (P.R 254, P.Y. 139 and P.Y. 42, mixed at a weight ratio of 36:10:54) and an acrylic resin as a binder resin are dispersed in propyl acetate at a weight ratio of 2:3 (mixed pigment:binder resin), thereby preparing a 7-weight % propyl acetate solution (coating solution F-1). This coating solution F-1 is applied on a PET substrate (manufactured by Toray Industries, Inc., thickness: 125 μm) as substrate 36, using a spin coater, and then dried. Comparative light absorption layer 1 having a thickness of 1.2 μm is thus prepared.

—Comparative Light Absorption Layer 2—

A pigment (P.R 254) and an acrylic resin as a binder resin are dispersed in propyl acetate at a weight ratio of 2:3 (mixed pigment:binder resin), thereby preparing a 20-weight % propyl acetate solution (coating solution F-3). This coating solution F-3 is applied on a PET substrate (manufactured by Toray Industries, Inc., thickness: 125 μm) as substrate 36, using an applicator having a gap of 50 μm, and then dried. Comparative light absorption layer 2 having a thickness of 6.4 μm is thus prepared.

—Measurement of Light-Shield Properties—

The absorption spectrum with respect to light of a wavelength region of from 300 nm to 800 nm of the above-prepared second light absorption layers 1 to 4 and comparative light absorption layers 1 and 2 is measured using a spectrometer (trade name: SPG-100ST, manufactured by Shimadzu Corporation), and the minimum absorbance in the wavelength region of from 300 nm to 550 nm is calculated. The results are shown in Table 1.

Further, the transmittance with respect to light of 660 nm of the above-prepared second light absorption layers 1 to 4 and comparative light absorption layers 1 and 2 is measured. The light of 660 nm is used for writing in the following exemplary display media. The results are shown in Table 1.

TABLE 1

| | | | Transmittance | Minimum absorbance in |
|---|---|---|---|---|
| | | Thickness | to light of | wavelength |
| | Pigment (ratio) | (μm) | 660 nm (%) | region of 300-550 nm |
| Second light | PR254:PY139:PY42 = | 6.5 | 90 | 4.9 |
| absorption layer 1 | 36:10:54 | | | |
| Second light | PR254:PY139:PY42 = | 8.3 | 90 | 6.2 |
| absorption layer 2 | 36:10:54 | | | |
| Second light | ZnO:PY83 = 1:1 | 5.5 | 90 | 4.1 |
| absorption layer 3 | | | | |
| Second light | ZnO:PY83 = 1:1 | 9.3 | 90 | 6.9 |
| absorption layer 4 | | | | |
| Comparative light | PR254:PY139:PY42 = | 1.2 | 90 | 0.9 |
| absorption layer 1 | 36:10:54 | | | |
| Comparative light | PR254 | 6.4 | 90 | 0.9 |
| absorption layer 2 | | | | |

### Example 1

### Preparation of Display Medium Display medium 12 having a structure shown in FIG. 1 is prepared. First, a charge generating layer is formed on an ITO film (thickness: 800 angstroms, corresponds to second electrode 22) provided on a PET film (thickness: 125 μm, corresponds to substrate 24).

Specifically, a chlorogalliumphthalocyanine having a diffraction peak in an X-ray diffraction spectrum at Bragg angles) (2θ±0.2°) of 7.4°, 16.6°, 25.5° and 28.3° as a charge generating material and polyvinyl butyral (trade name: S-LEC BX, manufactured by Sekisui Chemical Co., Ltd.) as a binder resin are dispersed at a weight ratio of 1:1 in butanol using a Dyno mill. A 4-weight % butanol dispersion (coating solution A) is thus prepared.

This coating solution A is applied on the ITO film by spin coating, and then dried. A charge generating layer having a thickness of 0.2 μm (corresponding to second charge generating layer 20C) is thus formed.

Subsequently, a charge transporting layer 20B is formed on second charge generating layer 20C. Specifically, a benzidine compound having the following structure as a charge transporting material and polycarbonate (bisphenol-Z, (poly(4,4′-cyclohexylidene diphenylamine carbonate))) as a binder resin are mixed at a weight ratio of 2:3, and dissolved in monochlorobenzene. A 10-weight % monochlorobenzene solution (coating solution B) is thus prepared.

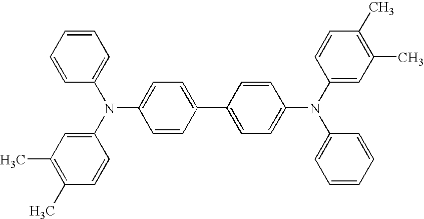

This coating solution B is applied on second charge generating layer 20C by spin coating, and dried. A charge transporting layer 20A having a thickness of 6.5 μm (corresponding to charge transporting layer 20B) is thus formed.

Further, a charge generating layer (first charge generating layer 20A) is formed on the charge transporting layer. Specifically, a charge generating layer having a thickness of 0.2 μm is formed on the charge transporting layer by applying coating solution A as prepared above, and drying the same. Photoconductive layer 20 is thus prepared.

On the thus formed photoconductive layer 20, a 3-weight % polyvinyl alcohol aqueous solution is applied by spin coating to form a polyvinyl alcohol film having a thickness of 0.2 μm as an isolation layer 21. Further, an adhesive layer 18 having a thickness of 1.2 μm is formed on the isolation layer 21 by applying a butyl acetate solution of a two-liquid-type polyurethane adhesive (trade name: TAKENATE/TAKELAC, manufactured by Mitsui Chemicals, Inc., A315/A50) and drying the same. A layer structure B is thus obtained (see FIG. 1).

On the other hand, a liquid crystal layer 17 (thickness: 50 μm) is formed on the ITO film (transparent electrode, corresponding to first electrode 15, thickness: 800 angstroms) formed on the PET substrate (thickness: 125 μm).

Specifically, a chiral nematic liquid crystal that selectively reflects light of a blue green color is prepared by melting 74.8 parts by weight of a nematic liquid having a positive dielectric anisotropy (E8, manufactured by Merck KGaA), 21 parts by weight of a chiral agent (CB15, manufactured by BDH Co., Ltd.) and 4.2 parts by weight of a chiral agent (R1011, manufactured by Merck KGaA), and then cooling the same to room temperature.

To 10 parts by weight of this blue green chiral nematic liquid crystal, 3 parts by weight of an adduct of xylenediisocyanate (3 mol) and trimethylol propane (1 mol) (D-110N, manufactured by Takeda Pharmaceutical Company Limited.) and 100 parts by weight of ethyl acetate are added to prepare a uniform, oil-phase solution.

On the other hand, 10 parts by weight of polyvinyl alcohol (trade name: POVAL 217EE, manufactured by Kuraray Co., Ltd.) are added to 1,000 parts by weight of hot ion exchange water, and stirred. The mixture is then allowed to stand to cool, and an aqueous-phase solution is prepared.

Subsequently, an oil-in-water emulsion (oil-phase droplets are dispersed in an aqueous phase) is prepared by dispersing 10 parts by weight of the oil-phase solution in 100 parts by weight of the aqueous-phase solution, using a mixer for domestic use to which an alternating voltage of 30V is applied by a transformer (trade name: SLIDAC, manufactured by Toshiba Corporation). This oil-in-water emulsion is stirred for two hours while heating the same in a water bath of 60° C. to complete interfacial polymerization, thereby obtaining liquid crystal microcapsules. The average diameter of the microcapsules is measured by a laser particle size distribution meter, and is estimated to be about 12 μm.

The thus obtained dispersion of liquid crystal microcapsules is filtered through a 38-μm stainless mesh, and then allowed to stand for a whole day. After removing a milky white supernatant liquid, a slurry of liquid crystal microcapsules having a solid content concentration of about 40% by weight is obtained. To this slurry, a 10-weight % polyvinyl alcohol solution, containing polyvinyl alcohol in an amount of ⅔ of the solid content in the slurry, is added to prepare a coating solution C.

A liquid crystal layer 17 (thickness: 50 μm corresponding to first electrode 15) is formed by applying coating solution C with a #44 wire bar on an ITO film (transparent electrode, thickness: 800 angstroms) that is formed as an electrode on a PET substrate 13 (thickness: 125 μm). Further, first light absorption layer 19 is formed on the thus formed liquid crystal layer 17 in the following manner.

A 10-weight % aqueous dispersion (coating solution D) is prepared by dispersing carbon black as a black pigment and polyvinyl alcohol (POVAL 217EE, manufactured by Kuraray Co., Ltd.) as a binder resin at a weight ratio of 1:5. This coating solution D is applied onto liquid crystal layer 17 with an applicator and dried, thereby forming first light absorption layer 19 having a thickness of 3 μm. Layer structure A is thus obtained.

Layer structure A and layer structure B as prepared above are laminated at 70° C. so that first light absorption layer 19 and adhesive layer 18 are in contact with each other. Layer structure C is thus obtained.

An adhesive layer 32 having a thickness of 1.2 μm is formed on the four sides of the outer surface (photoconductive layer 20 side) of a PET substrate (substrate 24), by applying a butyl acetate solution of a two-liquid-type polyurethane adhesive (trade name: TAKENATE/TAKELAC, manufactured by Mitsui Chemicals, Inc., A315/A50) and drying the same. This adhesive layer 32 is laminated with second light absorption layer 1 as prepared above at 70° C., thereby obtaining display medium 1.

### Example 2

Display medium 2 is prepared according to similar processes, raw materials and conditions to Example 1, except that second light absorption layer 2 as prepared above is used instead of second light absorption layer 1.

### Example 3

Display medium 3 is prepared according to similar processes, raw materials and conditions to Example 1, except that second light absorption layer 3 as prepared above is used instead of second light absorption layer 1.

### Example 4

Display medium 4 is prepared according to similar processes, raw materials and conditions to Example 1, except that second light absorption layer 4 as prepared above is used instead of second light absorption layer 1.

### Example 5

Display medium 5 is prepared according to similar processes, raw materials and conditions to Example 1, except that a stilbene compound having the aforementioned structure (I-1) is used instead of the benzidine compound as the charge transporting material.

### Example 6

Display medium 6 is prepared according to similar processes, raw materials and conditions to Example 1, except that a stilbene compound having the aforementioned structure (I-2) is used instead of the benzidine compound as the charge transporting material.

### Comparative Example 1

Comparative Example 1 is prepared according to similar processes, raw materials and conditions to Example 1, except that second light absorption layer 1 is not provided.

### Comparative Example 2

Comparative Example 2 is prepared according to similar processes, raw materials and conditions to Example 1, except that comparative light absorption layer 1 is used instead of second light absorption layer 1.

### Comparative Example 3

Comparative Example 3 is prepared according to similar processes, raw materials and conditions to Example 1, except that comparative light absorption layer 2 is used instead of second light absorption layer 1.

—Evaluation of Light Fastness—

The light fastness of display media as prepared in Examples 1 to 6 and Comparative Examples 1 to 3 are evaluated in the following manner.

Specifically, a driving voltage is applied between the electrodes (ITO electrodes corresponding to first electrode 15 and second electrode 22) of the display medium in an environment of 25° C. and 50% RH, and the display medium is exposed to light of 150 μJ (wavelength: 660 nm) for 0.2 seconds. Thereafter, the application of voltage is stopped and writing is conducted. The reflectance of the display medium when displaying a white background is measured using a spectrophotometer (trade name: CM-3600d, manufactured by Konica Minolta Sensing, Inc.)

As a result, the display media of Examples 1 to 6 exhibit a change in reflectance of 40% or more when a voltage of 600 V or more is applied, and the display media of Comparative Examples 1 to 3 also exhibit a change in reflectance of 40% or more when a voltage of 600 V or more is applied. Therefore, no substantial differences between the Examples and the Comparative Examples at an initial stage thereof (before being exposed to light as mentioned below) are recognized.

Subsequently, the display media of Examples 1 to 4 and Comparative Examples 1 to 3 are placed immediately beneath a fluorescent lamp (center portion of the fluorescent lamp, approximately 5 mm from the light source, luminance: approximately 25,000 lux), there by allowing photoconductive layers 20 of the display media to be exposed to light in an environment of 25° C. and 50% RH.

Further, photoconductive layers 20 of the display media of Examples 1, 5 and 6 and Comparative Example 1 are exposed to pseudo-sunlight (trade name: SUNTEST CPS+, manufactured by Toyo Seiki Seisaku-sho, Ltd., light source: xenone lamp, approximately 100,000 lux, illumination temperature: 25° C.).

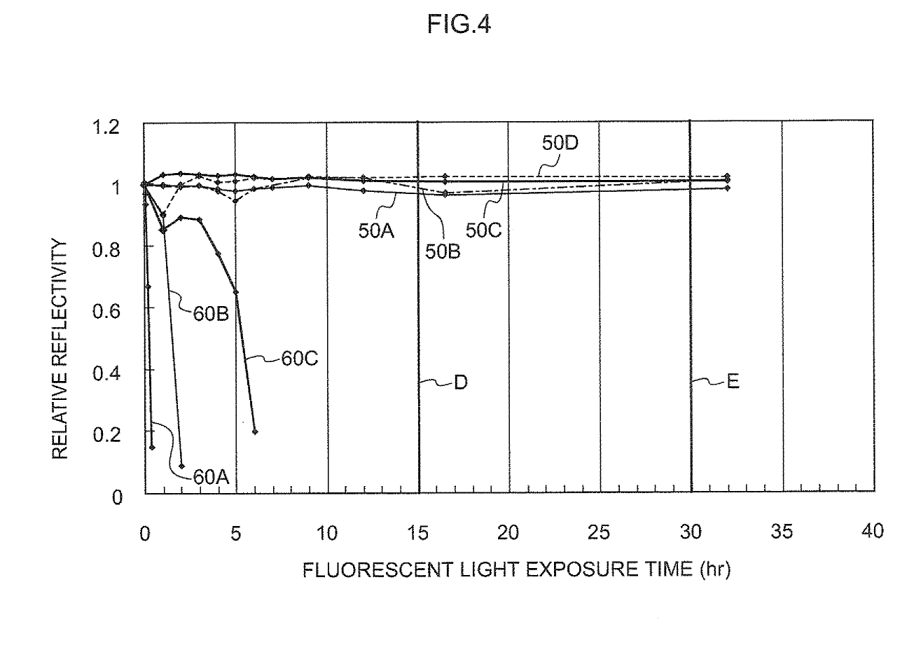

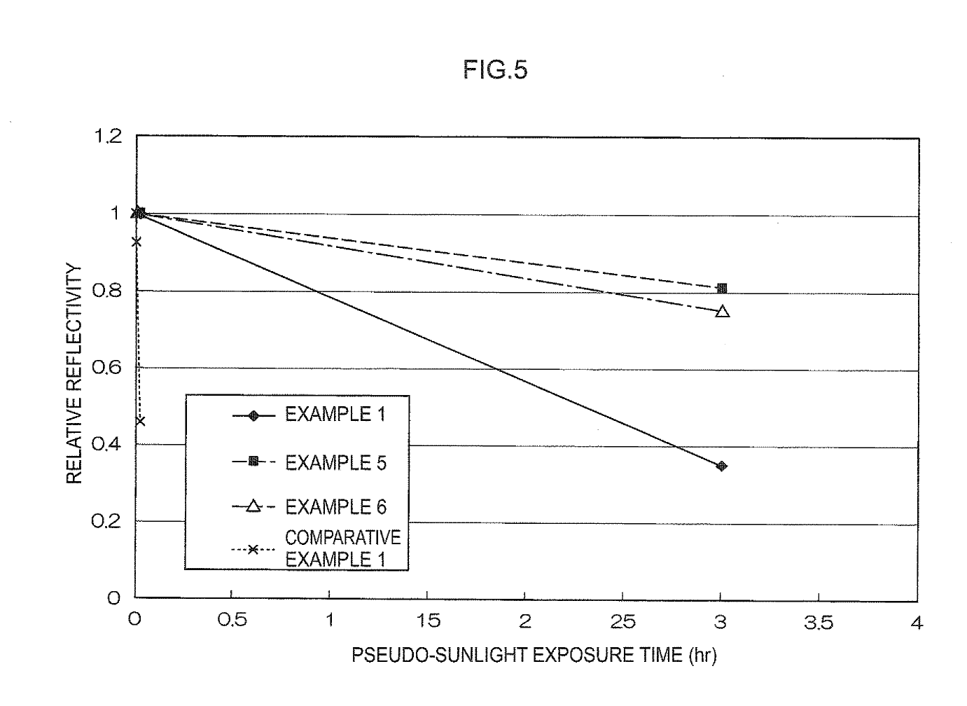

The relationship between the exposure time and the relative reflectance of each display medium is shown in FIGS. 4 and 5.

The relative reflectance is determined by the ratio of “reflectance after exposure” to “standard reflectance”.

The standard reflectance is measured after the proccesses of applying, to the display medium that is not exposed to light, a voltage of a value at which the reflectance changes by 40% or more; exposing the display medium to light of 150 μJ (wavelength: 660 nm) for 0.2 seconds; and stopping the application of voltage and conducting the writing to display a white background. The value of the standard reflectance is defined as 1.

Then, the reflectance after exposure is measured after the processes of applying, to the display medium after being exposed to light, a voltage of the same value as the above; exposing the same to light of the same amount for the same period as the above; and stopping the application of voltage and conducting the writing to display a white background.

In FIG. 4, line 50A represents the evaluation result of display medium 1; line 50B represents the evaluation result of display medium 2; line 50C represents the evaluation result of display medium 3; and line 50D represents the evaluation result of display medium 4. Further, in FIG. 4, line 60A represents the evaluation result of comparative display medium 1; line 60B represents the evaluation result of comparative display medium 2; and line 60C represents the evaluation result of comparative display medium 3.

As shown in FIG. 4, display media 1 to 4 as prepared in Examples 1 to 4 exhibit favorable light fastness with no significant reduction in the relative reflectivity over a long period of time, with respect to comparative display media 1 to 3 as prepared in Comparative Examples 1 to 3.

Specifically, in comparative display media 1 to 3 as prepared in Comparative Examples 1 to 3, the relative reflectivity thereof decreases to 0.2 or lower within a period of exposure of from 0.2 to 6 hours. On the other hand, in display media 1 to 4 as prepared in Examples 1 to 4, decrease in the relative reflectivity is not observed even when the display media are exposed to light for 15 hours (line D in FIG. 4), which is similar to placing the display medium in an indoor environment for half a year; or when the display media are exposed to light for 30 hours (line E in FIG. 4), which is similar to placing the display medium in an indoor environment for a year. As a result, the display media as prepared in Examples 1 to 4 exhibit an improved light fastness with respect to the display media as prepared in Comparative Examples 1 to 3.

Further, as shown in FIG. 5, the display media as prepared in Examples 5 and 6, in which a phthalocyanine compound is used as the charge generating material and a stilbene compound is used as the charge transporting material, exhibit an even more improved light fastness with respect to the display medium as prepared in Example 1, in which the aforementioned combination is not employed.

All publications, patent applications, and technical standards mentioned in this specification are herein incorporated by reference to the same extent as if each individual publication, patent application, or technical standard was specifically and individually indicated to be incorporated by reference.

What is claimed is:

1. A display medium comprising:
a first electrode;
a second electrode;
a liquid crystal layer provided between the first electrode and the second electrode;
a photoconductive layer provided between the second electrode and the liquid crystal layer, the photoconductive layer absorbing light of a predetermined wavelength used for writing, and thereby exhibiting an electrical characteristic corresponding to the intensity distribution of the light used for writing;
a first light absorption layer provided between the liquid crystal layer and the photoconductive layer, the first light absorption layer absorbing light transmitted through the liquid crystal layer;
a second light absorption layer provided at the side of the second electrode not facing the photoconductive layer, the second light absorption layer allowing transmission of the light used for writing and having an absorbance of 1 or more with respect to light of any wavelength in a range of from 300 nm to 550 nm.

2. The display medium according to claim 1, wherein the photoconductive layer comprises a charge generating layer comprising a charge generating material, and a charge transporting layer comprising a charge transporting material,
the charge generating material comprising a phthalocyanine compound, and the charge transporting material comprising a stilbene compound.

3. The display medium according to claim 2, wherein the phthalocyanine compound comprises at least one charge generating material selected from the group consisting of:
(1) a chlorogallium phthalocyanine having a diffraction peak in an X-ray diffraction spectrum at Bragg angles) (2θ±0.2°) of at least 7.4°, 16.6°, 25.5° and 28.3°;
(2) a chlorogallium phthalocyanine having a diffraction peak in an X-ray diffraction spectrum at Bragg angles) (2θ±0.2°) of at least 6.8°, 17.3°, 23.6° and 26.9°;
(3) a chlorogallium phthalocyanine having a diffraction peak in an X-ray diffraction spectrum at Bragg angles) (2θ±0.2°) of at least a position from 8.7° to 9.2°, 17.6°, 24.0°, 27.4° and 28.8°;
(4) a hydroxygallium phthalocyanine having a diffraction peak in an X-ray diffraction spectrum at Bragg angles) (2θ±0.2°) of at least 7.5°, 9.9°, 12.5°, 16.3°, 18.6°, 25.1° and 28.3°;
(5) a hydroxygallium phthalocyanine having a diffraction peak in an X-ray diffraction spectrum at Bragg angles) (2θ±0.2°) of at least 7.7°, 16.5°, 25.1°, and 26.6°;
(6) a hydroxygallium phthalocyanine having a diffraction peak in an X-ray diffraction spectrum at Bragg angles) (2θ±0.2°) of at least 7.9°, 16.5°, 24.4°, and 27.6°;
(7) a hydroxygallium phthalocyanine having a diffraction peak in an X-ray diffraction spectrum at Bragg angles) (2θ±0.2°) of at least 7.0°, 7.5°, 10.5°, 11.7°, 12.7°, 17.3°, 18.1°, 24.5°, 26.2°, and 27.1°;
(8) a hydroxygallium phthalocyanine having a diffraction peak in an X-ray diffraction spectrum at Bragg angles) (2θ±0.2°) of at least 6.8°, 12.8°, 15.8° and 26.0°;
(9) a hydroxygallium phthalocyanine having a diffraction peak in an X-ray diffraction spectrum at Bragg angles) (2θ±0.2°) of at least 7.4°, 9.9°, 25.0°, 26.2° and 28.2°;
(10) a titanyl phthalocyanine having a diffraction peak in an X-ray diffraction spectrum at Bragg angles) (2θ±0.2°) of at least 9.3° and 26.3°; and
(11) a titanyl phthalocyanine having a diffraction peak in an X-ray diffraction spectrum at Bragg angles) (2θ±0.2°) of at least 9.5°, 9.7°, 11.7°, 15.0°, 23.5°, 24.1° and 27.3°.

4. The display medium according to claim 2, wherein the stilbene compound is represented by the following formula (I): 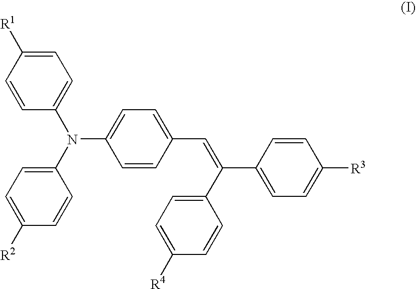
wherein, in formula (I), R¹, R², R³ and R⁴ each independently represent a hydrogen atom, a methyl group or an ethyl group.

5. The display medium according to claim 4, wherein the stilbene compound is at least one compound represented by the following formulas (I-1), (I-2) or (I-3):

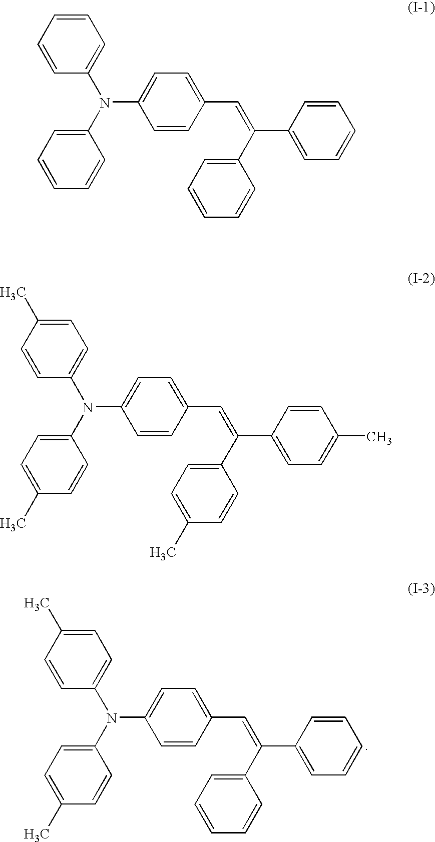

6. The display medium according to claim 1, wherein the second light absorption layer has an absorbance of 1 or more with respect to light of any wavelength in a range of from 300 nm to less than 600 nm.

7. The display medium according to claim 1, wherein the light used for writing has a wavelength of from 600 nm to 800 nm.

8. The display medium according to claim 1, wherein the second light absorption layer is formed from a non-water-soluble resin.

9. A display device comprising a display medium, a voltage application unit and an exposure unit, the display medium comprising:
a first electrode;
a second electrode;
a liquid crystal layer provided between the first electrode and the second electrode;
a photoconductive layer provided between the second electrode and the liquid crystal layer, the photoconductive layer absorbing light of a predetermined wavelength used for writing, and thereby exhibiting an electrical characteristic corresponding to the intensity distribution of the light used for writing;
a first light absorption layer provided between the liquid crystal layer and the photoconductive layer, the first light absorption layer absorbing light transmitted through the liquid crystal layer;
a second light absorption layer provided at the side of the second electrode not facing the photoconductive layer, the second light absorption layer allowing transmission of the light used for writing and having an absorbance of 1 or more with respect to light of any wavelength in a range of from 300 nm to 550 nm,
the voltage application unit applying a voltage to the first electrode and the second electrode, and
the exposure unit irradiating the display medium from the side of second light absorption layer with the light for writing.

10. The display device according to claim 9, wherein the photoconductive layer comprises a charge generating layer comprising a charge generating material, and a charge transporting layer comprising a charge transporting material,
the charge generating material comprising a phthalocyanine compound, and the charge transporting material comprising a stilbene compound.

11. The display device according to claim 10, wherein the phthalocyanine compound comprises at least one charge generating material selected from the group consisting of:
(1) a chlorogallium phthalocyanine having a diffraction peak in an X-ray diffraction spectrum at Bragg angles) (2θ±0.2°) of at least 7.4°, 16.6°, 25.5° and 28.3°;
(2) a chlorogallium phthalocyanine having a diffraction peak in an X-ray diffraction spectrum at Bragg angles) (2θ±0.2°) of at least 6.8°, 17.3°, 23.6° and 26.9°;
(3) a chlorogallium phthalocyanine having a diffraction peak in an X-ray diffraction spectrum at Bragg angles) (2θ±0.2°) of at least a position from 8.7° to 9.2°, 17.6°, 24.0°, 27.4° and 28.8°;
(4) a hydroxygallium phthalocyanine having a diffraction peak in an X-ray diffraction spectrum at Bragg angles) (2θ±0.2°) of at least 7.5°, 9.9°, 12.5°, 16.3°, 18.6°, 25.1° and 28.3°;
(5) a hydroxygallium phthalocyanine having a diffraction peak in an X-ray diffraction spectrum at Bragg angles) (2θ±0.2°) of at least 7.7°, 16.5°, 25.1°, and 26.6°;
(6) a hydroxygallium phthalocyanine having a diffraction peak in an X-ray diffraction spectrum at Bragg angles) (2θ±0.2°) of at least 7.9°, 16.5°, 24.4°, and 27.6°;
(7) a hydroxygallium phthalocyanine having a diffraction peak in an X-ray diffraction spectrum at Bragg angles) (2θ±0.2°) of at least 7.0°, 7.5°, 10.5°, 11.7°, 12.7°, 17.3°, 18.1°, 24.5°, 26.2°, and 27.1°;
(8) a hydroxygallium phthalocyanine having a diffraction peak in an X-ray diffraction spectrum at Bragg angles) (2θ±0.2°) of at least 6.8°, 12.8°, 15.8° and 26.0°;
(9) a hydroxygallium phthalocyanine having a diffraction peak in an X-ray diffraction spectrum at Bragg angles) (2θ±0.2°) of at least 7.4°, 9.9°, 25.0°, 26.2° and 28.2°;
(10) a titanyl phthalocyanine having a diffraction peak in an X-ray diffraction spectrum at Bragg angles) (2θ±0.2°) of at least 9.3° and 26.3°; and
(11) a titanyl phthalocyanine having a diffraction peak in an X-ray diffraction spectrum at Bragg angles) (2θ±0.2°) of at least 9.5°, 9.7°, 11.7°, 15.0°, 23.5°, 24.1° and 27.3°.

12. The display device according to claim 10, wherein the stilbene compound is represented by the following formula (I): 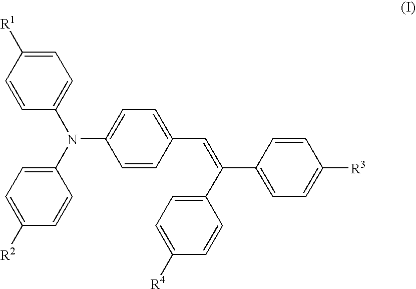
wherein, in formula (I), R¹, R², R³ and R⁴ each independently represent a hydrogen atom, a methyl group or an ethyl group.

13. The display device according to claim 12, wherein the stilbene compound is at least one compound represented by the following formulas (I-1), (I-2) or (I-3):

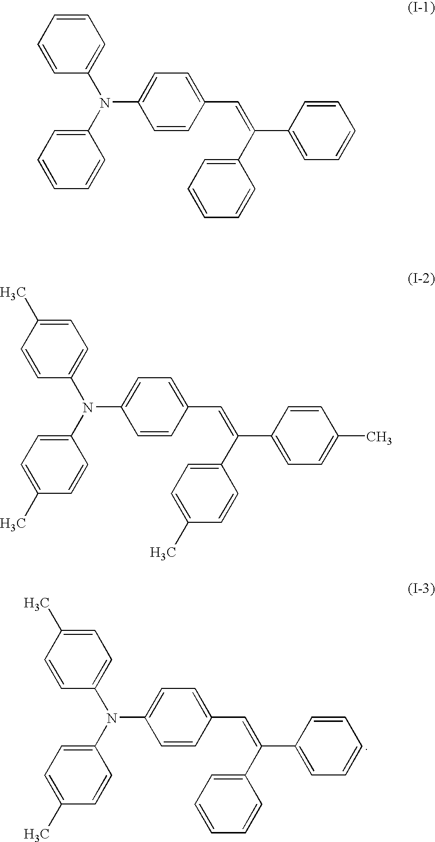

14. The display device according to claim 9, wherein the second light absorption layer has an absorbance of 1 or more with respect to light of any wavelength in a range of from 300 nm to less than 600 nm.

15. The display device according to claim 9, wherein the light used for writing has a wavelength of from 600 nm to 800 nm.

16. The display device according to claim 9, wherein the second light absorption layer is formed from a non-water-soluble resin.

17. A method of optical writing to display an image on the display medium according to claim 1, the method comprising:
applying a voltage to the first electrode and second electrode; and
irradiating the display medium from the side of second light absorption layer with the light for writing.

18. The method of optical writing according to claim 17, wherein the light used for writing has a wavelength of from 600 nm to 800 nm.
